(19) United States
(12) Patent Application Publication
(10) Pub. No.: US 2013/0167138 A1
(43) Pub. Date: Jun. 27, 2013

(54) METHOD AND APPARATUS FOR SIMULATING INSTALLATIONS

(71) Applicants: Pradeep Cyril Ekka, New Delhi (IN); Sandeep Handa, New Delhi (IN); Afroz Muzammil, New Delhi (IN)

(72) Inventors: Pradeep Cyril Ekka, New Delhi (IN); Sandeep Handa, New Delhi (IN); Afroz Muzammil, New Delhi (IN)

(21) Appl. No.: 12/576,479

(22) Filed: Oct. 9, 2009

(51) Int. Cl. G06F 9/445

(52) U.S. Cl. 717/175

(57) ABSTRACT

A method, apparatus and computer program product for simulation installation operations is presented. An installer software application is identified and is used for performing installation operations, and a payload to be installed by the installer software application is also identified. Installation of the payload by the installer software application is simulated, wherein an entry is made in a database to record operations that were performed rather than conventional installation operations. This simulation includes updating configuration information and product information for the payload in a product database and refraining from performing file copies.

### BACKGROUND

An installer software application (referred to simply as an “installer”) is used to build and install a file or sets of files to a computer system. This is accomplished through the use of payloads. A payload is a set of files, folders, registries, etc. bundled in a single file that is going to be deployed (installed) on the user machine. An installer is used to install, un-install or remove one or more payloads. An installer needs to be tested to verify that the installer operates correctly when used to install various images that must operate with other installed images. There are various machine states that have to be set up in order to verify that an installer performs as desired under various circumstances.

It is very tedious and time consuming to set up machines that are at particular states to verify the install/re-install and uninstall scenarios necessary for properly testing an installer software application. It is not always possible for the developer to verify code changes/fixes under all such scenarios. For instance, suppose that to verify a particular scenario it is necessary to have a certain software suite installed on the machine, setting up such a machine may take hours because the actual physical install has to happen which takes time. Again there might be use cases wherein there are multiple suites installed on the machine.

### SUMMARY

Conventional installers may suffer from a variety of deficiencies. One such deficiency is that verification of proper operation of an installer can be tedious, time-consuming and labor intensive. A normal sanity check of the installer can take several hours to certify that the bare minimum features of the installer are working as desired.

Embodiments of the invention significantly overcome such deficiencies and provide mechanisms and techniques that provide a method and apparatus for simulating installations.

In a particular embodiment of a method for simulating installations, an installer software application is identified. Also identified is a payload to be installed by the installer software application. The installation of the payload by the installer software application is simulated by performing database operations wherein an entry is made in a database to record operations that were performed rather than conventional installation operations (e.g. file copies and the like). This results in a dramatic reduction in the amount of time required to verify an installer software application is working correctly since actual file copies are not being performed in the simulation.

Other embodiments include a computer readable medium having computer readable code thereon for providing for simulating installations. The computer readable medium includes instructions for identifying an installer software application. The computer readable medium also includes instructions for identifying a payload to be installed by the installer software application. The computer readable medium further includes instructions for simulating installation of the payload by the installer software application, wherein the simulating installation of the payload includes performing database operations wherein an entry is made in a database to record operations that were performed rather than conventional installation operations.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides installation simulation as explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing installation simulation as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a computer device. The features of the invention, as explained herein, may be employed in computer devices and/or software systems for such devices such as those manufactured by Adobe Systems Incorporated of San Jose, Calif.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a block diagram of an installer in accordance with embodiments of the invention;

FIG. 2 illustrates an example computer system architecture for a computer system that performs installation simulation in accordance with embodiments of the invention; and

FIG. 3 depicts a flow diagram of a particular embodiment of a method of performing installation simulation in accordance with embodiments of the invention.

### DETAILED DESCRIPTION

Installation of a program (including drivers, plugins, etc.) by an installer is the act of putting the program onto a computer system so that it can be executed. Some software can be executed by simply copying it to a computer and executing it with no further action required, therefore no installation procedure as such is required. Other programs are supplied in a form not suitable for immediate execution, and require an installation procedure.

An installation program or installer is a computer program that installs files, such as applications, drivers, or other software, onto a computer. Some installers are specifically made to install the files they contain; other installers are general-purpose and work by reading the contents of the software package to be installed. Installation may include unpacking of files supplied in a compressed form, copying them to suitable locations, tailoring the software to suit the hardware and the user's preferences, providing information about the program to the operating system, and so on. The installer may test for system suitability and available mass storage space.

Common operations performed during software installations include creation or modification of: shared and non-shared program files, folders/directories, registry entries, configuration file entries, environment variables, and links or shortcuts. Given the complexity of a typical installation there are many factors that may interfere with its successful completion. In particular files that are leftover from old installations of the same program or an unstable situation of the operating system may all act to prevent a given program from installing and working correctly.

When an installer is developed, there is a need to test the installer. Various scenarios need to be tested to ensure that the installer is working properly. This can be tedious, time-consuming and compute intensive.

Embodiments of the presently described method and apparatus for simulating installations provide a way to work around this problem by allowing a simulated installation mode. In a simulated installation mode, for each payload to be installed, any data written to the product database (configuration data and product data) are allowed to occur, however any actual file copies are not performed. This provides a significant timesaving, as a large majority of the time spent during an installation is the actual copying of files to the machines hard drive. The product database is updated with payload properties, configuration data, registry entries and the like, (referred to as virtual machine state) while actual file copies are not performed. Since the product database is updated, it appears that the installation actually occurred. Inconsistency failures in the product database, as well as registry errors or conflicts can be determined in the same manner as if the installation actually occurred.

In a particular example, there may be a payload in one suite that conflicts with a payload in another suite. To test for this problem, it would be necessary to install the first suite (which can take several hours), then to install the second suite (which can again take several hours). It is only after the two installation operations that a problem (e.g. an inconsistency failure or payload conflict) can be determined.

Embodiments of the presently described method and apparatus for simulated installations provides savings both in terms of time and effort for both developers and quality engineers by verifying different install states, and by comparing the virtual machine state with the actual machine state. In such a manner a user can perform various test cases and combinations that are time consuming, for example suite coexistence scenarios.

The simulated install mode reduces the install time to verify different install states by comparing the virtual machine state with the actual machine state. The simulated install mode allows the performance of various test cases and combinations that are particularly time consuming (e.g., suite coexistence scenarios). The simulated install mode also provides a way for installer developers to verify various scenarios after feature implementations or any bug fixes.

Additionally, embodiments of the present invention provide a mechanism to speedily verify that the software products conform to the business policies. One such business policy is coexistence scenarios, wherein multiple products/suites are installed on end user machines. It is necessary to test various install scenarios to insure that the installed products operate properly. This includes coexistence of products between releases, for instance different versions of the same product.

Another coexistence scenario involves inter-component dependencies. A typical product comprises the actual core product component (payload) and additional supporting components (payloads). A person who is authoring the installer can define dependencies between these various components that comprise the installer. The dependencies can be of the form required, recommended or critical. Still another coexistence dependency involves upgrades and conflicts. The various components (payloads) that comprise the installer may individually have upgrade or conflict relationships with their prior versions. For upgrade relationships, if their prior versions are already installed on the machine they should be removed. If a later version is already installed on the machine, then the present payload should not be installed. A conflict involves wherein if a conflicting version is installed on the machine, this version cannot be installed.

The following terms will be used in describing embodiments of the present invention:

Installer Build System (IBS)—a whole set of software programs for building and deploying payloads.

IBS Kernel (IK)—a set of runtime libraries that installs/remove IK payloads.

Payload—A set of files, folders, registries, etc. bundled in a single file that is going to be deployed (installed) on the user machine.

IK command—Each payload has a database file that contains set of commands to be executed for each assets (files/folders or registry).

Product database (PDB)—PDB contains list of payloads that are already installed on the user machine. The PDB also contains the dependency information between two payloads.

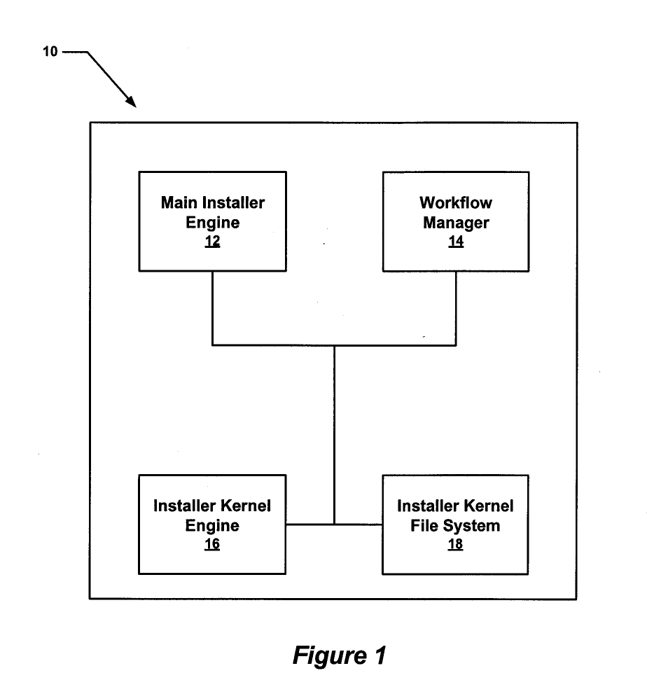

Referring now to FIG. 1, an example IBS system 10 is shown. IBS 10 is an installer system, and can be divided into four software components, a main installer engine 12, a workflow manager 14, an installer kernel engine 16, and an installer kernel file system (FS) 18 all of which communicate with each other. The workflow manager 14 contains all the logic to manage all the payloads being installed and/or removed, dependency computation, sequencing etc. The installer kernel engine 16 is a Dynamic Link Library (DLL) containing the logic for installing and/or removing payloads. The installer kernel file system 18 is a DLL containing the definitions of the various installer commands that are used to install and/or remove payloads, for instance InstallFile, DeleteFile, etc.

The main installer engine 12 is modified to accept “simulation” as an execution type via a command line argument (e.g. installMode=simulation”) and sets this value in a property map for the workflow manager 14, the installer kernel engine 16 and the installer kernel file system 18 to use.

The installer kernel engine 16 is modified to check for this new installMode and to perform database operations rather than file/directory/registry operations for install, re-install and uninstall scenarios. Corresponding to each command that was performed, an entry is made in a database which records operations that were performed by that install session.

In summary, the simulation mode takes a substantially smaller amount of time as compared to a full-fledged install. One difference between the normal installation mode and simulation mode is that the assets would not be physically installed on the machine, in some cases they would not even be unpacked for installation.

In an example, the main installer engine 12 manages all the installation operations to be performed. The workflow manager 14 manages a set of payloads to be installed for an installation session. The main installer engine 12 sequences the payloads and sends them to the installer kernel engine 16 for installation. The installer kernel engine 16 uses the installer kernel file system 18 to process commands for each payload. In simulation mode, each of the instructions that are going to write a file to the hard disk aren't actually performed. However, other operations such as updates to the product database with product information, configuration information and payload properties are performed. The physical payload installation has not happened, however configuration information and property information for that payload are placed in the product database. Since this information is in the product database, it appears to the rest of the system that an actual installation occurred. Inconsistency failures in the product database, as well as registry errors or conflicts can be determined in the same manner as if the installation actually occurred.

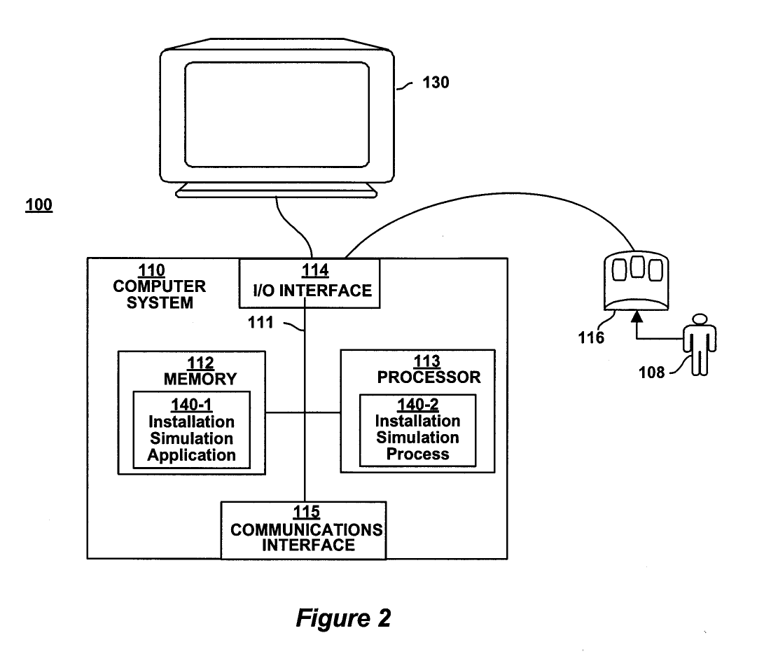

FIG. 2 is a block diagram illustrating example architecture of a computer system 110 that executes, runs, interprets, operates or otherwise performs an installation simulation operating application 140-1 and installation simulation operating process 140-2 suitable for use in explaining example configurations disclosed herein. The computer system 110 may be any type of computerized device such as a personal computer, workstation, portable computing device, console, laptop, network terminal or the like. An input device 116 (e.g., one or more customer/developer controlled devices such as a keyboard, mouse, etc.) couples to processor 113 through I/O interface 114, and enables a customer 108 to provide input commands, and generally control the graphical customer interface 160 that the installation simulation operating application 140-1 and process 140-2 provides on the display 130. As shown in this example, the computer system 110 includes an interconnection mechanism 111 such as a data bus or other circuitry that couples a memory system 112, a processor 113, an input/output interface 114, and a communications interface 115. The communications interface 115 enables the computer system 110 to communicate with other devices (i.e., other computers) on a network (not shown).

The memory system 112 is any type of computer readable medium, and in this example, is encoded with a installation simulation operating application 140-1 as explained herein. The installation simulation operating application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of a installation simulation operating application 140-1. Execution of a installation simulation operating application 140-1 in this manner produces processing functionality in the installation simulation operating process 140-2. In other words, the installation simulation operating process 140-2 represents one or more portions or runtime instances of a installation simulation operating application 140-1 (or the entire a installation simulation operating application 140-1) performing or executing within or upon the processor 113 in the computerized device 110 at runtime.

It is noted that example configurations disclosed herein include the installation simulation operating application 140-1 itself (i.e., in the form of un-executed or non-performing logic instructions and/or data). The installation simulation operating application 140-1 may be stored on a computer readable medium (such as a floppy disk), hard disk, electronic, magnetic, optical, or other computer readable medium. A installation simulation operating application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a installation simulation operating application 140-1 in the processor 113 as the installation simulation operating process 140-2. Those skilled in the art will understand that the computer system 110 may include other processes and/or software and hardware components, such as an operating system not shown in this example.

A display 130 need not be coupled directly to computer system 110. For example, the billing repository operating application 140-1 can be executed on a remotely accessible computerized device via the network interface 115. In this instance, the graphical customer interface 160 may be displayed locally to a customer 108 of the remote computer, and execution of the processing herein may be client-server based.

During operation, processor 113 of computer system 100 accesses memory system 112 via the interconnect 111 in order to launch, run, execute, interpret or otherwise perform the logic instructions of the installation simulation application 140-1. Execution of installation simulation application 140-1 produces processing functionality in installation simulation process 140-2. In other words, the installation simulation process 140-2 represents one or more portions of the installation simulation application 140-1 (or the entire application) performing within or upon the processor 113 in the computer system 100.

It should be noted that, in addition to the installation simulation process 140-2, embodiments herein include the installation simulation application 140-1 itself (i.e., the un-executed or non-performing logic instructions and/or data). The installation simulation application 140-1 can be stored on a computer readable medium such as a floppy disk, hard disk, or optical medium. The installation simulation application 140-1 can also be stored in a memory type system such as in firmware, read only memory (ROM), or, as in this example, as executable code within the memory system 112 (e.g., within Random Access Memory or RAM).

In addition to these embodiments, it should also be noted that other embodiments herein include the execution of installation simulation application 140-1 in processor 113 as the installation simulation process 140-2. Those skilled in the art will understand that the computer system 100 can include other processes and/or software and hardware components, such as an operating system that controls allocation and use of hardware resources associated with the computer system 100.

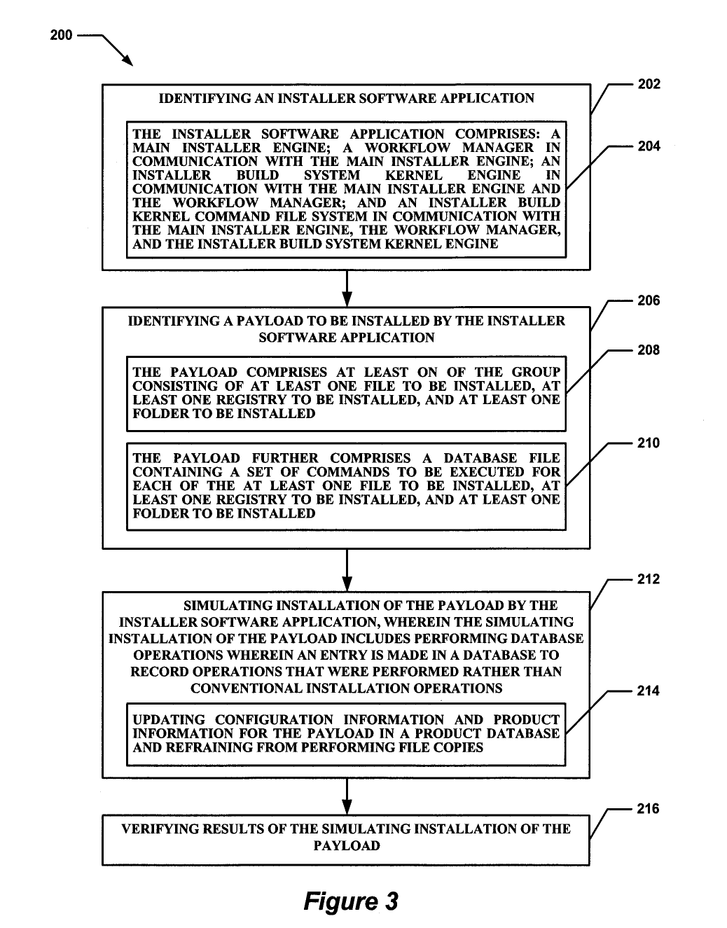

A flow chart of a particular embodiment of the presently disclosed method is depicted in FIG. 3. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 3, a particular embodiment of a method 200 for installation simulation is shown. Method 200 begins with processing block 202, which recites identifying an installer software application. As shown in processing block 204, in a particular embodiment the installer application includes a main installer engine, a workflow manager in communication with the main installer engine, an installer kernel engine in communication with the main installer engine and the workflow manager, and an installer kernel file system in communication with the main installer engine, the workflow manager, and the installer kernel engine. The main installer engine is operable in a conventional installer mode and in a simulation mode. The workflow manager includes logic to manage installation of a payload, removal of a payload, dependency computations and sequencing operations. The installer kernel engine includes logic for installing a payload and for removing a payload. The installer kernel file system includes definitions for commands used to perform the installing of a payload and definitions for commands used to perform the removing a payload.

Processing block 206 discloses identifying a payload to be installed by the installer software application. Processing block 208 states the payload comprises at least on of the group consisting of at least one file to be installed, at least one registry to be installed, and at least one folder to be installed. Processing block 210 discloses the payload further comprises a database file containing a set of commands to be executed for each of the at least one file to be installed, at least one registry to be installed, and at least one folder to be installed.

Processing continues with processing block 212, which states simulating installation of the payload by the installer software application, wherein the simulating installation of the payload includes performing database operations wherein an entry is made in a database to record operations that were performed rather than conventional installation operations. In conventional installation operations, configuration data and product data updates are made, as well as the performing of file copies, which can take a large amount of time. As shown in processing block 214, the simulating installation of the payload by the installer software application comprises updating configuration information and product information for the payload in a product database and refraining from performing actual file copies. This results in significant timesavings for the simulated installation mode as compared to the conventional installation mode.

Processing block 216 recites comprising verifying results of the simulating installation of the payload. Inconsistency failures in the product database, registry errors or conflicts can be determined at this stage.

The device(s) or computer systems that integrate with the processor(s) may include, for example, a personal computer(s), workstation(s) (e.g., Sun, HP), laptop(s), handheld computer(s) or device(s), netbook computer(s), television set-top box(es), mobile device(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the Internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

1. A computer-implemented method in which a computer system performs operations comprising:
identifying an installer software application;
identifying a payload to be installed by said installer software application; and
simulating installation of said payload by said installer software application, wherein said simulating installation of said payload comprises recording one or more operations associated with the installation of the payload and refraining from performing one or more file copy operations; and
verifying, based on the simulating of the installation of the payload, that the simulated installation conforms to one or more coexistence scenarios such that there is no conflict with another installed suite or version.

2. The method of claim 1 wherein said simulating installation of said payload by said installer software application comprises recording at least one of configuration information and product information for said payload in a product database.

3. The method of claim 1 wherein the verifying comprises testing each of multiple scenarios that differ from one another.

4. The method of claim 1 wherein said payload comprises at least one of the group consisting of at least one file to be installed, at least one registry to be installed, and at least one folder to be installed.

5. The method of claim 4 wherein said payload further comprises a database file containing a set of commands to be executed for each of said at least one file to be installed, at least one registry to be installed, and at least one folder to be installed.

6. The method of claim 1 wherein said installer software application comprises:
a Main Installer Engine;
a Workflow Manager in communication with said Main Installer Engine;
an Installer Kernel Engine in communication with said Main Installer Engine and said Workflow Manager; and
an Installer Kernel File System in communication with said Main Installer Engine, said Workflow Manager, and said Installer Kernel Engine.

7. The method of claim 6 wherein said Main Installer Engine is operable in an installer mode and in a simulation mode.

8. The method of claim 6 wherein said Workflow Manager includes logic to manage installation of a payload, removal of a payload, dependency computations and sequencing operations.

9. The method of claim 6 wherein said Installer Kernel Engine includes logic for Installing a payload and for removing a payload.

10. The method of claim 6 wherein said Installer Kernel File system includes definitions for commands used to perform said installing a payload and definitions for commands used to perform said removing a payload.

11. A non-transitory computer readable storage medium having computer readable code thereon for simulation installation operations, the medium including instructions in which a computer system performs operations comprising:
identifying an installer software application;
identifying a payload to be installed by said installer software application;
simulating installation of said payload by said installer software application, wherein said simulating installation of said payload includes performing one or more database operations wherein an entry is made in a database to record one or more operations associated with the installation of the payload and refraining from performing one or more file copy operations;
verifying, based on the simulating of the installation of the payload, that the simulated installation conforms to one or more coexistence scenarios such that there is no conflict with another installed suite or version.

12. The computer readable storage medium of claim 11 wherein said simulating installation of said payload by said installer software application comprises updating at least one of configuration information and product information for said payload in a product database.

13. The computer readable storage medium of claim 11 wherein said payload comprises at least one of the group consisting of at least one file to be installed, at least one registry to be installed, and at least one folder to be installed.

14. The computer readable storage medium of claim 13 wherein said payload further comprises a database file containing a set of commands to be executed for each of said at least one file to be installed, at least one registry to be installed, and at least one folder to be installed.

15. The computer readable storage medium of claim 11 wherein said installer software application comprises:
a main installer engine software component;
a workflow manager software component in communication with said main installer engine software component;
an installer kernel engine software component in communication with said main installer engine software component and said workflow manager software component; and
an installer kernel file system software component in communication with said main installer engine software component, said workflow manager software component, and
said installer kernel engine software component.

16. The computer readable storage medium of claim 15 wherein said main installer engine software component is operable in a conventional installer mode and in a simulation mode.

17. The computer readable storage medium of claim 15 wherein said workflow manager software component includes logic to manage installation of a payload, removal of a payload, dependency computations and sequencing operations.

18. The computer readable storage medium of claim 15 wherein said installer kernel engine software component includes logic for installing a payload and for removing a payload.

19. The computer readable storage medium of claim 15 wherein said installer kernel file system software component includes definitions for commands used to perform said installing a payload and definitions for commands used to perform said removing a payload.

20. A computer system comprising:
a memory;
a processor;
a communications interface;
an interconnection mechanism coupling the memory, the processor and the communications interface; and
wherein the memory is encoded with an application providing installation simulation operations that when performed on the processor, provides a process for processing information, the process causing the computer system to perform the operations of:
identifying an installer software application;
identifying a payload to be installed by said installer software application;
simulating installation of said payload by said installer software application; and
verifying, based on the simulating of the installation of the payload, that the simulated installation conforms to one or more coexistence scenarios such that there is no conflict with another installed suite or version.
